(19) United States
(12) Patent Application Publication
(10) Pub. No.: US 2002/0099864 A1
(43) Pub. Date: Jul. 25, 2002

(54) Do-nothing temporary driver

(76) Inventor: David C. Henkemeyer, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/769,154

(22) Filed: Jan. 24, 2001

(51) Int. Cl. G06F 9/54

(52) U.S. Cl. 709/310

(57) ABSTRACT

Upon installation of a new hardware or software component into a system, the operating system requires the user to identify a driver for that component, from among a plurality of drivers in perhaps different and unspecified locations. The invention enables the user to identify a common, do-nothing driver in a predetermined, known location, to satisfy the operating system's request, and to have the do-nothing driver subsequently deinstalled and a desired driver to be installed without the user having to specify the location of the desired driver.

### BACKGROUND OF THE INVENTION

1. Technical Field of the Invention

The present invention relates generally to the installation of drivers or the like in a computer system.

2. Background Art

FIG. 1 shows a system 10 which includes internet service provider equipment 12. The equipment 12 is of either a first type (type 1) or a second type (type 2). The internet service provider equipment is connected to a communication network 14 such as a telephone system or a cable system or other suitable communication means. There may be plural internet service providers and/or plural communication networks, but in the interest of simplicity and clarity, only a single example of each is shown.

Also connected to the communication network are one or more instances of user equipment 16. One 18 of the user equipments is shown in greater detail. The user equipment includes an operating system (OS) which has two or more possible interfaces (OS Interface 1, OS Interface 2) through which a service of the operating system may be accessed. In other words, a specific function of the operating system may be accessed via two or more different paths or ports or mechanisms. In the example shown, the operating system includes a network services mechanism (not shown) which other software can access via two or more interfaces (OS Interface 1, OS Interface 2), and the user equipment has been enhanced by the installation of a DSL card over which the user intends to access his internet service provider 12. Depending upon which type of back-end equipment the internet service provider uses, the user's DSL card will need to utilize either a first DSL driver (DSL Driver 1) or a second DSL driver (DSL Driver 2) to access the OS through the first or second interface, respectively. Typically, only one of the drivers and one of the OS interfaces will be installed at any given time.

FIG. 2 illustrates a typical method practiced in the prior art for installation and configuration of a system such as shown in FIG. 1. The user installs (20) the hardware, such as the DSL card. The OS, if it supports Plug and Play, will detect (22) the newly-installed DSL card at the next bootup, or perhaps immediately in the case of a DSL card and system which is hot plug ready. The OS will launch (24) a Wizard which prompts the user to identify the location of the DSL driver to be used with that DSL card, whereupon the user may browse the computer's file system to locate the correct driver. Typically, the driver will be on a CD-ROM which will have separate drivers in separate directories for each of the possible OS interfaces that the DSL card may use, such as the PPPoA/NDISWAN interface and the RFC 1483 Bridged Ethernet/NDIS interface.

Once the user has selected a driver, the Wizard installs (28) that driver. Then the user must manually configure (30) various settings in the OS, DLLs, and so forth. These may be scattered in various locations throughout the computer's systems, and may be accessed and set via a variety of different mechanisms. Typically, the user's manual will attempt to guide the user through this process, albeit with historically poor efficacy.

Generally, the user will need to reboot (32) the system in order for the changes to take effect. If (34) the user was successful—and perhaps lucky, as well—the OS and its components will be complete and properly configured, the OS will now have the necessary components, upgrades, patches, and so forth to handle the selected driver, and the system will work correctly (36), including the newly-installed DSL card.

Frequently, however, the system will not be completely correctly configured, and (38) some part of the system will not operate, or will operate poorly. Generally, the computer will not provide the user with any indication of what is wrong, nor how to fix it. As one example, a frequent error is that the original OS installation did not include the DLLs or other components necessary to provide the functionality of the desired OS interface, and the user did not cause it to be installed during the process of installing and configuring the DSL card.

### BRIEF DESCRIPTION OF THE DRAWINGS

The invention will be understood more fully from the detailed description given below and from the accompanying drawings of embodiments of the invention which, however, should not be taken to limit the invention to the specific embodiments described, but are for explanation and understanding only.

FIG. 1 shows one exemplary system as in the prior art.

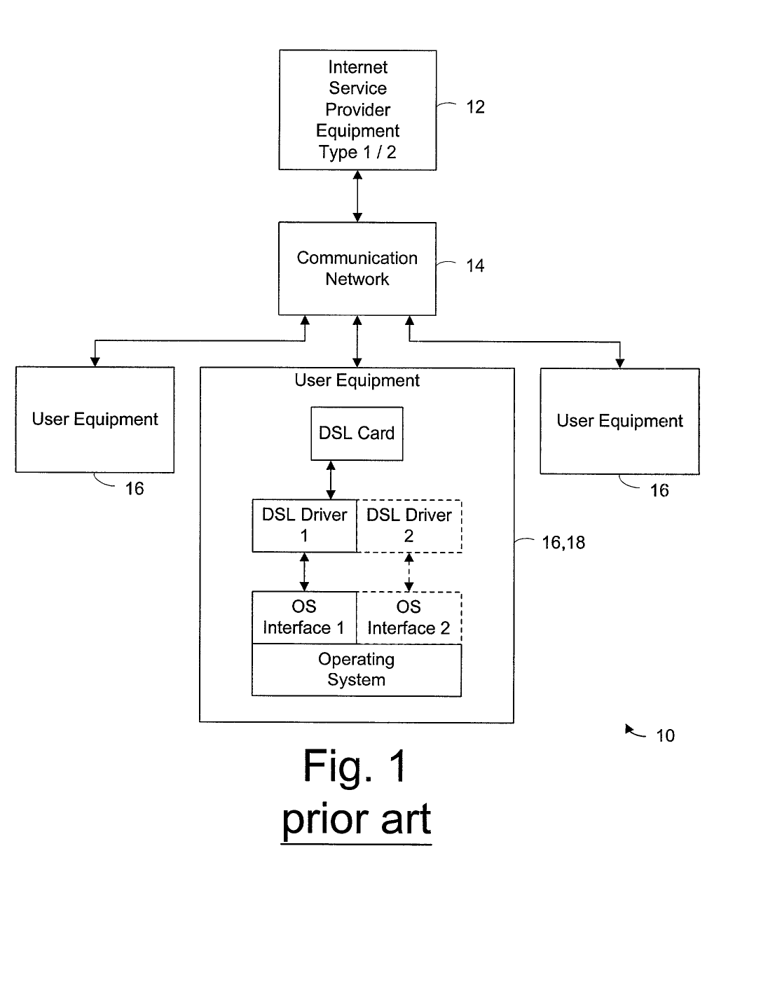

FIG. 2 shows an exemplary flowchart of one method practiced in the prior art.

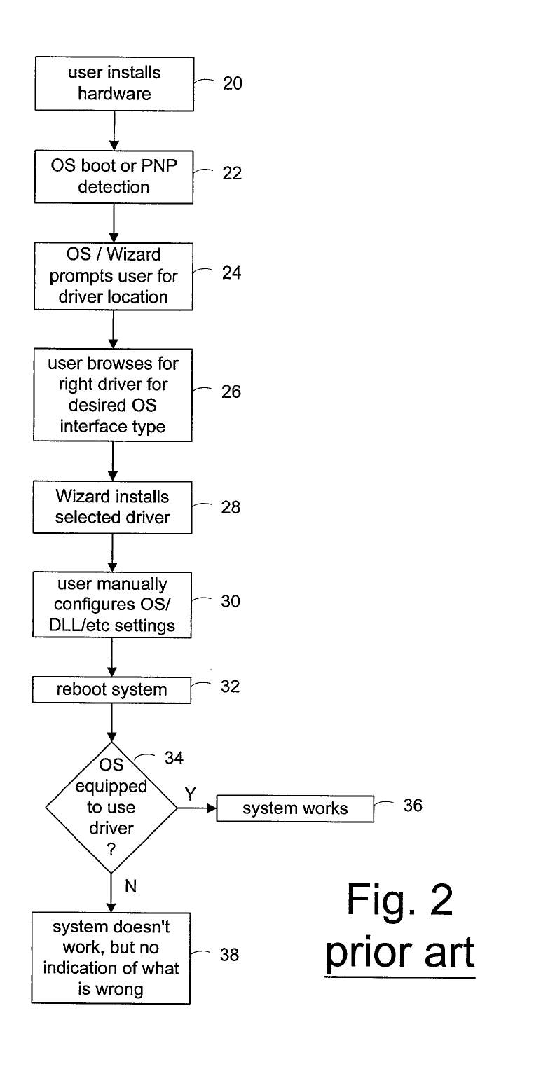

FIG. 3 shows an exemplary flowchart of one embodiment of a method of the invention.

FIG. 4 shows an exemplary embodiment of a system incorporating the invention.

### DETAILED DESCRIPTION

The invention is being described with reference to one specific embodiment, in which, upon the installation of a hardware device into a computer, the computer's operating system requires the installation of a driver software for the hardware device, and in which the operating system has two or more interfaces between itself and hardware devices of the general type to which the newly-installed hardware device belongs. However, the skilled reader will readily appreciate that the invention may be practiced in a variety of other embodiments, applications, and settings. For example, it may be used in the installation of a new software application, rather than in the installation of a new hardware device. Or, it may be used in conjunction with an application, rather than an operating system, having plural interfaces. Or, it may be used in a system which is not a conventional personal computer or the like, such as in a network router, or in an embedded control system, or other suitable system. For purposes of illustration and ease of explanation, the invention will be described in specific terms of a DSL card being installed into a PC running the Windows 98 operating system.

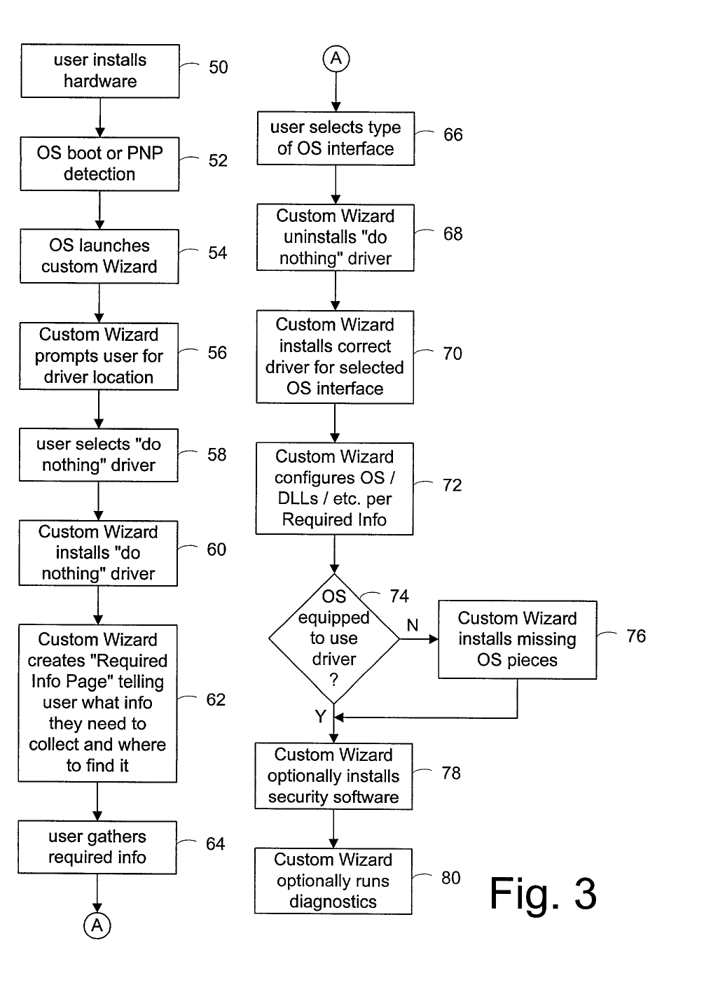

FIG. 3 illustrates one exemplary method practiced according to this invention. The user installs (50) the DSL card, and the OS detects (52) the DSL card at the next bootup or upon PNP detection.

The OS launches (54) a Wizard which, in some embodiments, may be a custom Wizard somewhat different in operation than the standard Wizard provided by the OS. The Wizard prompts (56) the user for the location of the DSL card's driver. However, rather than the user hunting through multiple alternative drivers in myriad possible locations, the user selects (58) a single common driver which may advantageously be stored in a commonly-accepted and widely-known location, such as in the root directory of the CD-ROM for example. This common driver may, in some embodiments, be a “do nothing” driver which does not necessarily accomplish anything actually related to the DSL card; rather, the function of the “do nothing” driver may be simply to satisfy the OS's demand for the user to identify the location of “the driver”.

It is not necessarily the case that the custom, do-nothing driver accomplishes nothing. In some embodiments, it may perform temporary tasks, or it may perform one-time setup or configuration tasks which are common to the plurality of ultimate driver installations. In other embodiments, it may perform tasks which are not strictly necessary for the ultimate installation. Furthermore, it is not necessarily the case that the custom driver or the ultimately-installed driver be a “driver” in the strictest Windows sense of the word. In some embodiments, each may be an information file (.INF file), some setup application files, documentation and help files, compressed driver files, a single file or multiple files, a Registry configuration, a virtual device driver file (.VXD file or .SYS file), a combination of those, and so forth. In other OS environments, each may be something different.

In the case of the Custom Wizard, it may advantageously create (62) a “Required Information Page” which gathers into a single location a list of data which the user needs to gather, and some indication of where these data may be found. Such data may include, for example: IP address, subnet mask, default gateway, DNS servers, OS interface type (all obtained from the ISP or the ISP's documentation), VPI/CPI, and driver encapsulation method (all obtained from the telco or the DSL provider). The user then gathers (64) the indicated data from the correct sources.

One of the pieces of data will typically be which type of OS interface the internet service provider's equipment expects to work with. The user may find that info from the printed materials that came with the DSL card, or by calling the internet service provider. Once the info is known, the user tells (66) the Wizard, typically by selecting from predetermined options, such as by picking one of two or more radio buttons in a conventional Windows dialog box or wizard page. The Wizard uninstalls (68) the “do nothing” common driver, and installs (70) the correct driver for the selected OS interface. One advantageous method is for the plural different drivers to be stored in compressed and/or encrypted form on the CD-ROM, with the Wizard knowing where each is stored and how to decompress/decrypt it. Decompression and/or decryption may individually or jointly be termed “decoding”. The user is relieved of the responsibility of knowing where to find the right driver.

The Custom Wizard configures (72) the OS, DLLs, Windows Registry, and other such settings, according to the “Required Info” gathered by the user. The user is relieved of the responsibility of knowing where and how to set the various configurations according to this data.

If (74) the required OS interface is not installed, or the OS does not have all the necessary components, upgrades, patches, etc. to handle the selected driver, the Custom Wizard installs (76) the missing pieces. For example, if the internet service provider expects that the DSL card will access the OS via the PPPoA interface, but the corresponding NDIS5 software is not installed to enable NDISWAN access to the NDIS service of Windows, the Custom Wizard will install the NDISWAN component of NDIS. The user is relieved of the responsibility of determining whether the OS is completely installed/upgraded/equipped.

While FIG. 3 has been described in terms of a method, it should also be understood to represent a machine-accessible medium having recorded or encoded or otherwise represented thereon instructions, routines, operations, control codes, or the like, which, when executed by or otherwise utilized by the machine, cause the machine to perform the method as described above or other embodiments thereof which are within the scope of this disclosure.

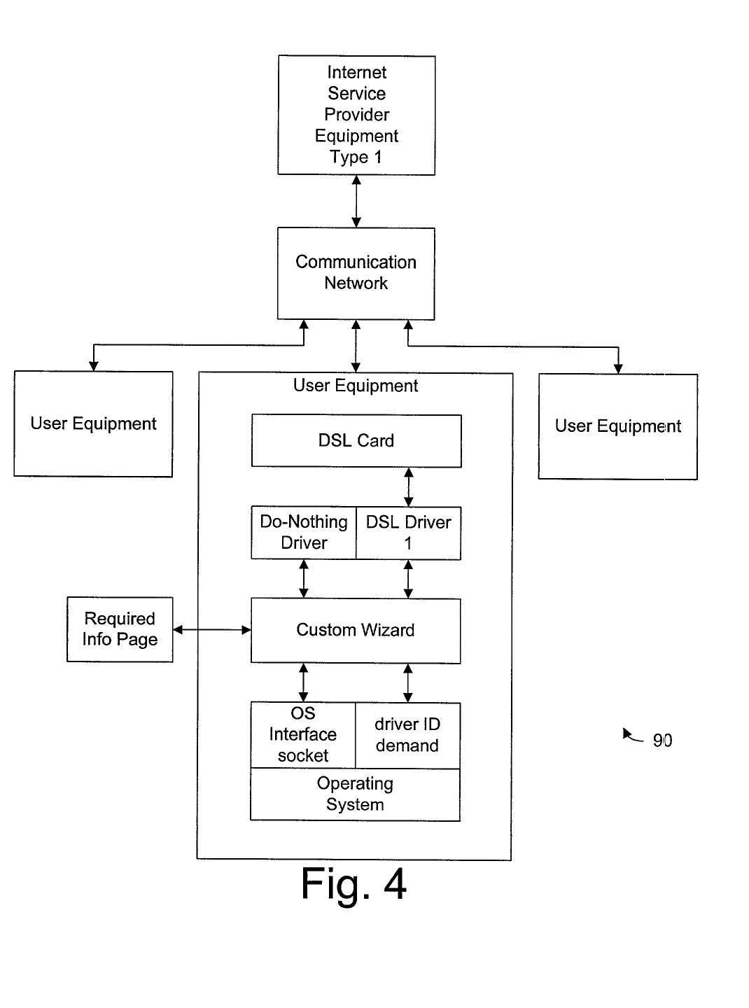

FIG. 4 illustrates a system 90 according to the invention. The user equipment includes the conventional operating system that has OS interfaces or sockets (only one of which is shown) and which makes a demand for the user to identify the driver for the newly-installed DSL card. The user equipment, along with other units of user equipment (which may or may not utilize the invention), are coupled via a conventional communication network to different types of internet service provider equipment (only a single type 1 is shown, for purposes of illustration).

The “do nothing” common driver is installed in response to the OS's driver ID demand, the custom wizard generates the required info page, the user gathers and provides the required information, and the custom wizard selects and installs the correct driver (in FIG. 4, this is DSL Driver 1 to go with the ISP equipment type 1, for example) and deinstalls the do nothing driver. Although the do nothing driver and the real driver are both illustrated in FIG. 4, the reader will appreciate that it is not necessarily the case that they both exist in the system at the same point in time, and that this and other aspects of FIG. 4 are merely for the purpose of teaching the invention and not limiting it.

While the invention has been described with reference to specific embodiments, the skilled reader will appreciate that it may be practiced in a wide variety of other embodiments. The reader will further appreciate that, for example, the relevant aspects of the illustrated operating system may be present in other types of software or such, which are not necessarily operating systems, yet the principles of this invention apply equally well in such cases. The reader will further appreciate that what has been discussed herein as a “wizard” may be implemented in a wide variety of formats, some of which may not fall into some definitions of “wizard”. Similarly, what has been illustrated as a “driver” is intended to cover a variety of other instantiations.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the invention. The various appearances “an embodiment,” “one embodiment,” or “some embodiments” are not necessarily all referring to the same embodiments.

If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

### Appendix A

William E. Alford, Reg. No. 37,764; Farzad E. Amini, Reg. No. 42,261; William Thomas Babbitt, Reg. No. 39,591; Carol F. Barry, Reg. No. 41,600; Jordan Michael Becker, Reg. No. 39,602; Lisa N. Benado, Reg. No. 39,995; Bradley J. Bereznak, Reg. No. 33,474; Michael A. Bernadicou, Reg. No. 35,934; Roger W. Blakely, Jr., Reg. No. 25,831; R. Alan Burnett, Reg. No. 46,149; Gregory D. Caldwell, Reg. No. 39,926; Andrew C. Chen, Reg. No. 43,544; Thomas M. Coester, Reg. No. 39,637; Donna Jo Coningsby, Reg. No. 41,684; Florin Corie, Reg. No. 46,244; Dennis M. deGuzman, Reg. No. 41,702; Stephen M. De Klerk, Reg. No. P46,503; Michael Anthony DeSanctis, Reg. No. 39,957; Daniel M. De Vos, Reg. No. 37,813; Justin M. Dillon, Reg. No. 42,486; Sanjeet Dutta, Reg. No. P46,145; Matthew C. Fagan, Reg. No. 37,542; Tarek N. Fahmi, Reg. No. 41,402; George Fountain, Reg. No. 37,374; James Y. Go, Reg. No. 40,621; James A. Henry, Reg. No. 41,064; Willmore F. Holbrow III, Reg. No. P41,845; Sheryl Sue Holloway, Reg. No. 37,850; George W Hoover II, Reg. No. 32,992; Eric S. Hyman, Reg. No. 30,139; William W. Kidd, Reg. No. 31,772; Sang Hui Kim, Reg. No. 40,450; Walter T. Kim, Reg. No. 42,731; Eric T. King, Reg. No. 44,188; Erica W. Kuo, Reg. No. 42,775; George B. Leavell, Reg. No. 45,436; Kurt P. Leyendecker, Reg. No. 42,799; Gordon R. Lindeen III, Reg. No. 33,192; Jan Carol Little, Reg. No. 41,181; Robert G. Litts, Reg. No. 46,876; Julio Loza, Reg. No. P47,758; Joseph Lutz, Reg. No. 43,765; Michael J. Mallie, Reg. No. 36,591; Andre L. Marais, under 37 C.F.R. §10.9(b); Paul A. Mendonsa, Reg. No. 42,879; Clive D. Menezes, Reg. No. 45,493; Chun M. Ng, Reg. No. 36,878; Thien T. Nguyen, Reg. No. 43,835; Thinh V. Nguyen, Reg. No. 42,034; Dennis A. Nicholls, Reg. No. 42,036; Daniel E. Ovanezian, Reg. No. 41,236; Kenneth B. Paley, Reg. No. 38,989; Gregg A. Peacock, Reg. No. 45,001; Marina Portnova, Reg. No. P45,750; Michael A. Proksch, Reg. No. 43,021; William F. Ryann, Reg. 44,313; James H. Salter, Reg. No. 35,668; William W. Schaal, Reg. No. 39,018; James C. Scheller, Reg. No. 31,195; Jeffrey S. Schubert, Reg. No. 43,098; George Simion, Reg. No. P47,089; Jeffrey Sam Smith, Reg. No. 39,377; Maria McCormack Sobrino, Reg. No. 31,639; Stanley W. Sokoloff, Reg. No. 25,128; Judith A. Szepesi, Reg. No. 39,393; Vincent P. Tassinari, Reg. No. 42,179; Edwin H. Taylor, Reg. No. 25,129; John F. Travis, Reg. No. 43,203; Joseph A. Twarowski, Reg. No. 42,191; Kerry D. Tweet, Reg. No. 45,959; Mark C. Van Ness, Reg. No. 39,865; Thomas A. Van Zandt, Reg. No. 43,219; Lester J. Vincent, Reg. No. 31,460; Glenn E. Von Tersch, Reg. No. 41,364; John Patrick Ward, Reg. No. 40,216; Mark L. Watson, Reg. No. P46,322; Thomas C. Webster, Reg. No. P46,154; and Norman Zafman, Reg. No. 26,250; my patent attorneys, and Raul Martinez, Reg. No. 46,904, my patent agents; of BLAKELY, SOKOLOFF, TAYLOR & ZAFMAN LLP, with offices located at 12400 Wilshire Boulevard, 7th Floor, Los Angeles, Calif. 90025, telephone (310) 207-3800, and Alan K. Aldous, Reg. No. 31,905; Robert D. Anderson, Reg. No. 33,826; Joseph R. Bond, Reg. No. 36,458; Richard C. Calderwood, Reg. No. 35,468; Paul W. Churilla, Reg. No. P47,495; Jeffrey S. Draeger, Reg. No. 41,000; Cynthia Thomas Faatz, Reg. No. 39,973; Scan Fitzgerald, Reg. No. 32,027; John N. Greaves, Reg. No. 40,362; John F. Kacvinsky, Reg No. 40,040; Seth Z. Kalson, Reg. No. 40,670; David J. Kaplan, Reg. No. 41,105; Charles A. Mirho, Reg. No. 41,199; Leo V. Novakoski, Reg. No. 37,198; Naomi Obinata, Reg. No. 39,320; Thomas C. Reynolds, Reg. No. 32,488; Kenneth M. Seddon, Reg. No. 43,105; Mark Seeley, Reg. No. 32,299; Steven P. Skabrat, Reg. No. 36,279; Howard A. Skaist, Reg. No. 36,008; Steven C. Stewart, Reg. No. 33,555; Raymond J. Werner, Reg. No. 34,752; Robert G. Winkle, Reg. No. 37,474; Steven D. Yates, Reg. No. 42,242, and Charles K. Young, Reg. No. 39,435; my patent attorneys, Thomas Raleigh Lane, Reg. No. 42,781; Calvin E. Wells; Reg. No. P43,256, Peter Lam, Reg. No. 44,855; Michael J. Nesheiwat, Reg. No. P47,819; and Gene I. Su, Reg. No. 45,140; my patent agents, of INTEL CORPORATION; and James R. Thein, Reg. No. 31,710, my patent attorney; with fill power of substitution and revocation, to prosecute this application and to transact all business in the Patent and Trademark Office connected herewith.

What is claimed is:

1. A method comprising:
receiving a request to select one of a plurality of available system elements to be installed;
receiving an identification of a first system element which is not of the plurality of available system elements;
installing the first system element;
deinstalling the first system element; and
installing the one of the plurality of available system elements.

2. The method of claim 1 wherein:
the identification of the first system element comprises an indication of a location of the first system element.

3. The method of claim 1 wherein:
the identification of the first system element comprises an indication of a filename of the first system element.

4. The method of claim 1 wherein:
the plurality of system elements comprise a plurality of device drivers; and
the first system element comprises a first device driver having substantially different functionality than the plurality of device drivers.

5. The method of claim 4 wherein:
the first device driver comprises a do-nothing driver.

6. A method of installing a device driver for a newly-installed hardware device in a system, the method comprising:
installing a first device driver;
deinstalling the first device driver; and
installing an operative device driver which enables the hardware device and the system to operate together.

7. The method of claim 6 wherein the first device driver does not enable the hardware device and the system to operate together.

8. The method of claim 6 further comprising, prior to installing the first device driver:
receiving a request from an operating system of the system to identify the operative device driver from among a plurality of possible device drivers.

9. A method of installing a device driver for a hardware device in a computer having an operating system and executing under control of a user, the method comprising:
providing a plurality of drivers, any of which may become installed as the device driver;
providing a common driver which may not become installed as the device driver;
the operating system requesting that the user identify the device driver;
receiving from the user an identification of the common driver as the device driver;
installing the common driver;
receiving from the user an identification of an operating system interface through which the hardware device should communicate with the operating system;
deinstalling the common driver; and
installing one of the plurality of drivers as the device driver, in accordance with the identification of the operating system interface.

10. The method of claim 9 wherein the hardware device comprises a communication device.

11. The method of claim 10 wherein the hardware device comprises a DSL card.

12. The method of claim 11 wherein the operating system interface is selected from a group comprising at least an NDISWAN interface and an NDIS interface.

13. The method of claim 11 wherein the operating system interface is selected from a group comprising at least a PPPoA interface and an RFC 1483 Bridged Ethernet interface.

14. A machine-accessible medium including thereon instructions which, when executed by a machine, cause the machine to perform a method comprising:
receiving from an operating system of the machine a request to identify a driver;
prompting a user to identify the driver;
receiving from the user an identification of a common driver;
delivering the identification of the common driver to the operating system to satisfy the operating system's request;
installing the common driver;
receiving from the user an identification of an operating system interface through which a component is to access the operating system;
deinstalling the common driver;
installing a first driver from a plurality of available drivers for the component, the first driver being selected from the plurality in accordance with the identification of the operating system interface.

15. The machine-accessible medium of claim 14 including thereon further instructions which, when executed by the machine, cause the machine to perform the method further comprising:
preparing a list of data which the user is to collect;
presenting the list to the user;
receiving the data from the user; and
configuring one or more features of the machine in accordance with the data.

16. The machine-accessible medium of claim 14 including thereon further instructions which, when executed by the machine, cause the machine to perform the method further comprising:
determining whether the operating system is sufficiently complete to enable the operating system interface; and
if not, further installing the operating system to enable the operating system interface.

17. The machine-accessible medium of claim 14 wherein the common driver is a do-nothing driver.

18. The machine-accessible medium of claim 14 wherein the common driver is stored in a root directory of a removable storage device.

19. A method of satisfying an operating system's request that a user identify a software component to be installed, in the presence of a plurality of possible such software components, the method comprising:
providing to the operating system an identification of a placeholder software component which is not one of the plurality of possible software components;
installing the placeholder software component;
deinstalling the placeholder software component; and
installing one of the plurality of possible software components.

20. The method of claim 19 further comprising the deinstalling being done after and in response to:
prompting the user to gather data; and
receiving the data from the user.

21. The method of claim 20 further comprising the installing one of the plurality of possible software components being done after and in response to:
receiving from the user an identification of one of a plurality of types of interface through which the respective possible software components are able to access the operating system.

22. The method of claim 21 further comprising:
decoding the one of the plurality of possible software components prior to its installation.

23. The method of claim 21 wherein the software components comprise drivers.

24. The method of claim 23 wherein the drivers comprise DSL drivers.

25. The method of claim 23 further comprising:
determining whether the operating system is a complete enough install to enable operation of the software component to be installed; and, if not,
installing additional elements of the operating system.

26. An apparatus for use with equipment of a first predetermined type, the apparatus comprising:
an operating system including a plurality of interfaces to equipment of a corresponding plurality of types, one of which is the first predetermined type, and including a driver ID demander; and
a wizard including a common driver which, when identified to the driver ID demander satisfies the driver ID demander's requirement to identify one of the plurality of interfaces.

27. The apparatus of claim 26 wherein the common driver comprises a do-nothing driver.

28. The apparatus of claim 26 further comprising:
a driver of the first predetermined type; and
the wizard being adapted to deinstall the common driver upon installation of the driver of the first predetermined type.

29. An apparatus for installation into a device to connect the device to equipment of a first predetermined type, the device including software which includes a plurality of interfaces to equipments of a plurality of types including the first predetermined type and which requests an identification of a driver in response to installation of a device that utilizes one of the plurality of interfaces, the apparatus comprising:
a hardware device for providing communication to the equipment;
a driver of the first predetermined type;
a common driver; and
a wizard for installing the common driver in response to the software requesting the identification of the driver, and for deinstalling the common driver and installing the driver of the first predetermined type in response to receiving information identifying the equipment as being of the first predetermined type.

30. The apparatus of claim 29 wherein the equipment is internet service provider equipment and wherein:
the hardware device comprises a DSL card.

31. The apparatus of claim 30 wherein:
the common driver is a do-nothing driver.
